(19) United States
(12) Patent Application Publication
(10) Pub. No.: US 2009/0324807 A1
(43) Pub. Date: Dec. 31, 2009

(54) METHOD FOR FORMING A POROUS MATERIAL

(76) Inventors: Jih-Perng Leu, Taipei City (TW); Kuo-Yuan Hsu, Taipei City (TW); Hsin-Ling Hsu, Taipei City (TW); Guan-Yu Chen, Taipei City (TW); Nobuo Takasaka, Taipei City (TW); Shi-Tsung Hung, Taipei City (TW)

Correspondence Address: SINORICA, LLC, 2275 Research Blvd., Suite 500, ROCKVILLE, MD, 20850, US

(21) Appl. No.: 12/147,651

(22) Filed: Jun. 27, 2008

(51) Int. Cl. B05D 5/12

(52) U.S. Cl. 427/58

(57) ABSTRACT

A method for forming a porous material is to mix a porous first basic material with a sacrificial material compatible with the first basic material to let the sacrificial material permeate into the pores of the first basic material to form a first finished product. Subsequently, the first finished product is mixed with a second basic material and heated over the vaporization temperature of the sacrificial material to let the ingredients of the second basic material change and increase viscous force and impossible to enter the pores of the first basic material. Simultaneously, the sacrificial material is heated and vaporized to exhaust out of the pores of the first basic material, disabling the second basic material to permeate into the pores of the first basic material and thus forming a second finished product for reserving the ingredients in the pores of the first basic material.

### BACKGROUND OF THE INVENTION

1. Field of the Invention

This invention relates to a pore-sealing technique, particularly to a method for forming a porous material.

2. Description of the Prior Art

Nowadays, in a semiconductor manufacturing process, the elements of integrated circuit are miniaturized gradually, but this will increase time delay in electronic signal transmission between metallic connecting lines and cause high power loss under high frequency. Therefore, for lowering time delay of signal transmission and elevating operation velocity of elements, it is necessary to employ multi-layered metal conductor connecting lines and leads of low resistivity or insulating materials of low dielectric coefficient. The low dielectric-coefficient (low-k) material commonly used is formed by mixing a low dielectric-coefficient and porous inorganic substance with an organic substance to let the inorganic substance permeate into the organic substance for lowering its dielectric coefficient and the coefficient of thermal expansion and enhancing its mechanical strength.

Although the conventional inorganic substance has its interior formed with numerous pores for containing air and lowering dielectric coefficient, yet, after the inorganic substance is mixed with the organic substance, the organic substance will be mixed to permeate into the pores of inorganic substance and produce a caulking phenomenon, thus rendering the inorganic substance impossible to lower the dielectric coefficient in its interior.

### SUMMARY OF THE INVENTION

The objective of this invention is to offer a method for forming a porous material in which a porous first basic material is first mixed with a sacrificial material that is compatible with the first basic material, letting the sacrificial material permeate into the pores of the first basic material to form a first finished product. Next, the first finished product is mixed with a second basic material and then their mixture is heated over the vaporization temperature of the sacrificial material to let the ingredients of the second basic material changed to increase viscous force and impossible to get into the pores of the first basic material, and meanwhile the sacrificial material is heated and vaporized to exhaust out of pores of the first basic material to form a second finished product. Thus, the second basic material is impossible to permeate into the pores of the first basic material, able to reserve the ingredients in the pores of the first basic material. By so designing, after the second basic material is heated, its ingredients will be changed to produce high viscosity by polymerization reaction and impossible to permeate into the pores of the first basic material, and simultaneously the sacrificial material will exhaust out of the pores of the first basic material, thus able to prevent the second basic material from permeating into the pores of the first basic material and hence increase the ingredient content in the pores of the first basic material.

### BRIEF DESCRIPTION OF DRAWINGS

This invention will be better understood by referring to the accompanying drawings, wherein:

FIG. 1 is a partial magnified flow chart of a method for forming a porous material in the present invention;

FIG. 2 is a pore-sealing process table showing five types of a sacrificial material covering up the pores of a first basic material in the present invention;

FIG. 3 is an analysis chart for the five types shown in FIG. 2 through test of thermo-gravimetric analysis (TGA);

FIG. 4 is a data table showing the surface area and the pore volume of the sacrificial material after the sacrificial material is mixed with the first basic material in the present invention;

FIG. 5 an ingredient proportional table of the sacrificial material mixed with the first basic material in the present invention;

FIG. 6 is a data table of the proportion of BET (specific surface area) in the present invention; and

FIG. 7 is a dielectric constant and modulus, GPa table of the sacrificial material of units A1, A2 and A3 shown in FIG. 5.

### DETAILED DESCRIPTION OF THE PREFERRED EMBODIMENT

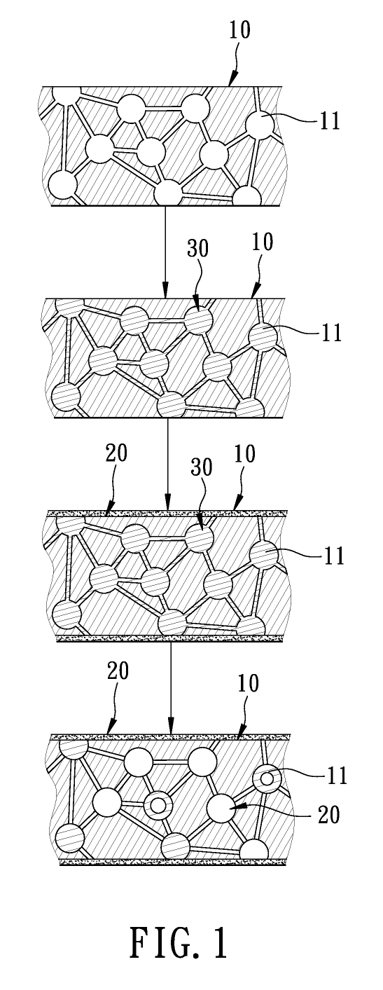

A preferred embodiment of a method for forming a porous material to be employed in a semiconductor manufacturing process and in a chip packaging process for lowering dielectric coefficient in the present invention, as shown in FIG. 1, includes the following steps.

(1) A first step is to select a porous first basic material 10, a second basic material 20 and a sacrificial material 30. The first basic material 10 is inorganic, and the porous and inorganic materials to be optionally used include silica, alumina oxide, silica-alumina, carbon-doped oxide (CDO), fluorinated silicate glass (FSG), calcium carbonate, alumina phosphate, alumina arsenate, alumina germanate, clay (kaolin, montmorillonite, or mica powder), glass fiber and carbon fiber. In this preferred embodiment, silica is selected for use. The second basic material 20 is organic and the organic materials to be optionally used include epoxy resin, acryl resin (acrylate), polyimide and polyurethane, and in this preferred embodiment, epoxy resin is selected for use. The sacrificial material, which is permeable and compatible with the first basic material 10 but incompatible with the second basic material 20, is siloxane, wax or the like, and in this preferred embodiment, hexamethyl cyclotrisiloxane is selected for use and its structure is:

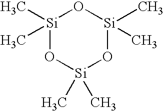

The melting point of the sacrificial material 30 is 65° C. while its boiling point is about 134° C., and the sacrificial material could be other similar materials.

(2) A second step is to have the sacrificial material 30 of a preset proportion and the first basic material 10 heated over the melting point of the sacrificial material 30 (about 65° C.˜100° C.) and then evenly mixed for one hour, and their mixing modes can adopt closed thermal melting or solvent treatment or other heating treatments to enable the sacrificial material 30 to permeate into the pores 11 of the first basic material 10. After mixed evenly, the mixture is kept stationary until its temperature drops to room temperature to form a first finished product.

(3) A third step is to mix the first finished product with the second basic material 20 and have their mixture heated over the boiling point of the sacrificial material 30 in cooperation with the cross-linking reaction temperature condition of the second basic material 20. This reaction temperature condition is to have the temperature rising from room temperature up to 140° C.˜170° C. at a speed of 2° C. per minute and then maintain the temperature for one hour to let the molecule of the second basic material 20 polymerized and hardened and impossible to flow back and permeate into the pores 11 of the first basic material 10. When the second basic material 20 is polymerized, the sacrificial material 30 will synchronously vaporize and exhaust out of the pores 11 of the first basic material 10, and the high viscosity produced by polymerization action of the second basic material 20 disables the second basic material 20 to permeate into the pores 11 of the first basic material 10, but has the second basic material 20 covering up the outer side of the first basic material 10, thus enabling the first basic material 10 to completely reserve the original porosity of its pores 11 and forming a second finished product with low dielectric coefficient.

In order to further understand the feature of the invention, the operational technique and expected effects and how to use the invention is to be described.

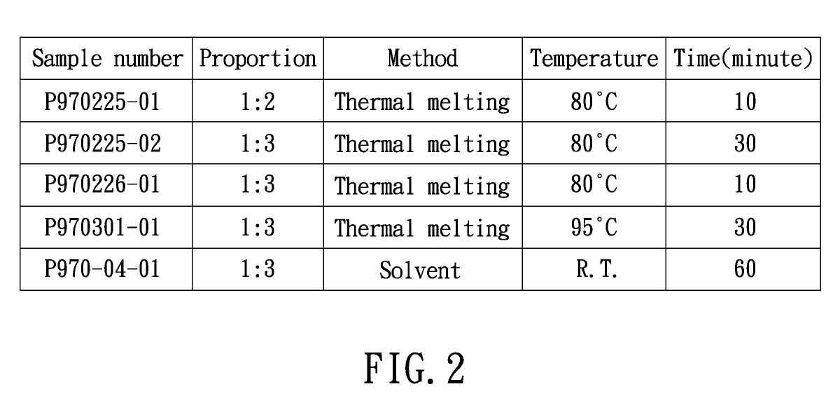

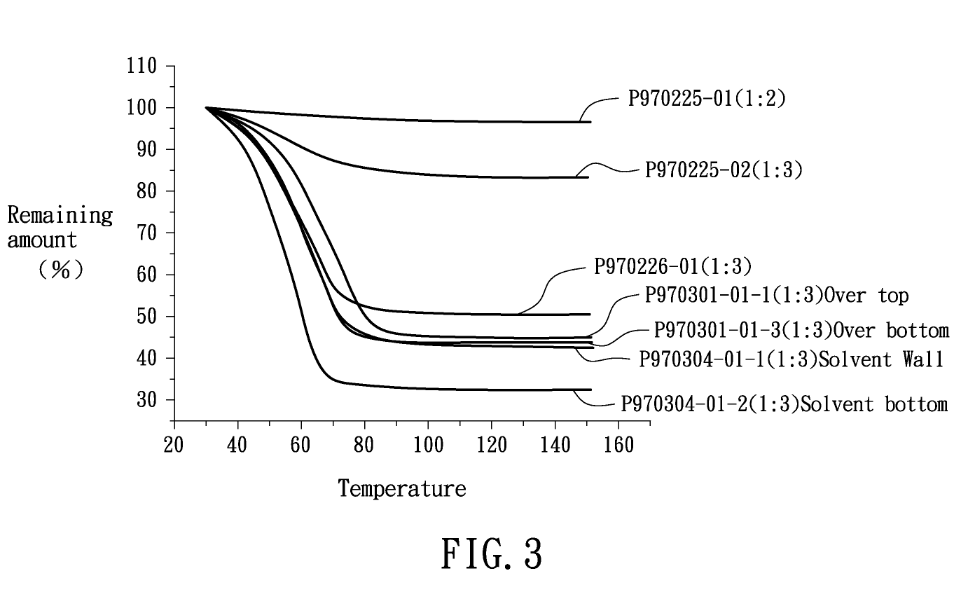

The method for forming a porous material is herein applied to chip package for collating different proportions and mixing modes to put forward results for studying pore-sealing effects. FIG. 2 is a pore-sealing process table showing that the sacrificial material 30 covers up the pores 11 of the first basic material 10 with five different-type heating processes. The first four types (P970225-01, P970225-02, P970226-01 and P970301-01) respectively have the sacrificial material 30 and the first basic material 10 mixed together by means of closed thermal melting as described in the second step of this invention, while the last type (P970304-01) has the sacrificial material 30 and the first basic material 10 mixed together by means of solvent treatment as described in the second step. FIG. 3 is an analysis chart of the five-type heating processes shown in FIG. 2 through a test of thermo-gravimetric analysis (TGA), and it is known from this analysis chart that the curved line of the P970304-01 descends faster than the other curved lines; therefore, it is clear that the efficiency of controlling the remaining amount of the sacrificial material 30 by solvent treatment is better than that by closed thermal melting.

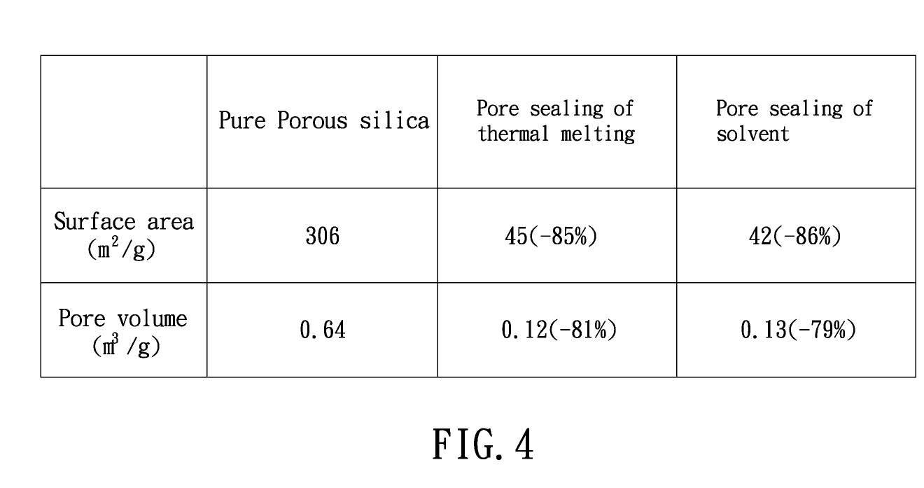

FIG. 4 is a data table showing the surface area and the pore volume of the sacrificial material 30 after the sacrificial material 30 is mixed with the first basic material 10. This table indicates that the original surface area of the pure porous silica is 306 m²/g and its original pore volume is 0.64 m³/g, but the surface area and the pore volume of the porous silica, which are produced through a mixing mode of closed thermal melting or solvent treatment, are reduced to the minimum, with only a little value difference produced between the two mixing modes.

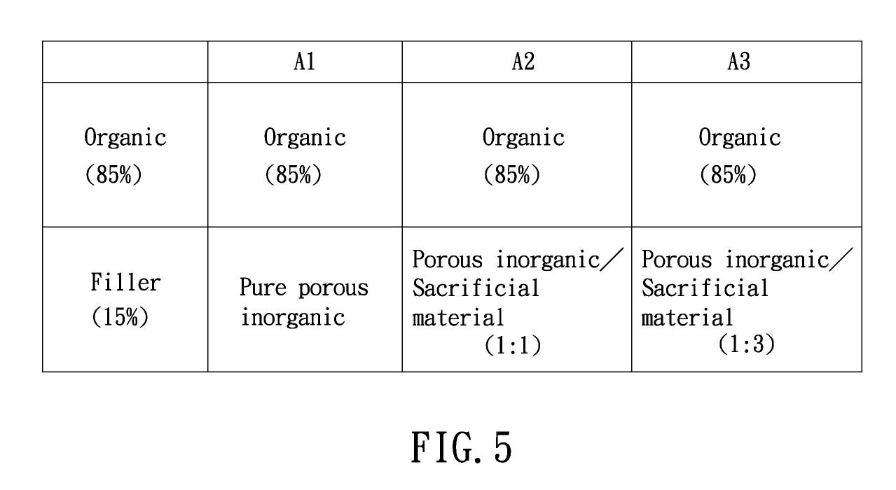

FIG. 5 is an ingredient distribution table of the sacrificial material 30, divided into three units: unit A1, unit A2 and unit A3. The unit A1 is to have the second basic material 20 mixed with the pure first basic material 10, while the unit A2 and the unit A3 are to have the second basic material 20 respectively mixed with a mixture of the sacrificial material 30 and the first basic material 10 with different proportions.

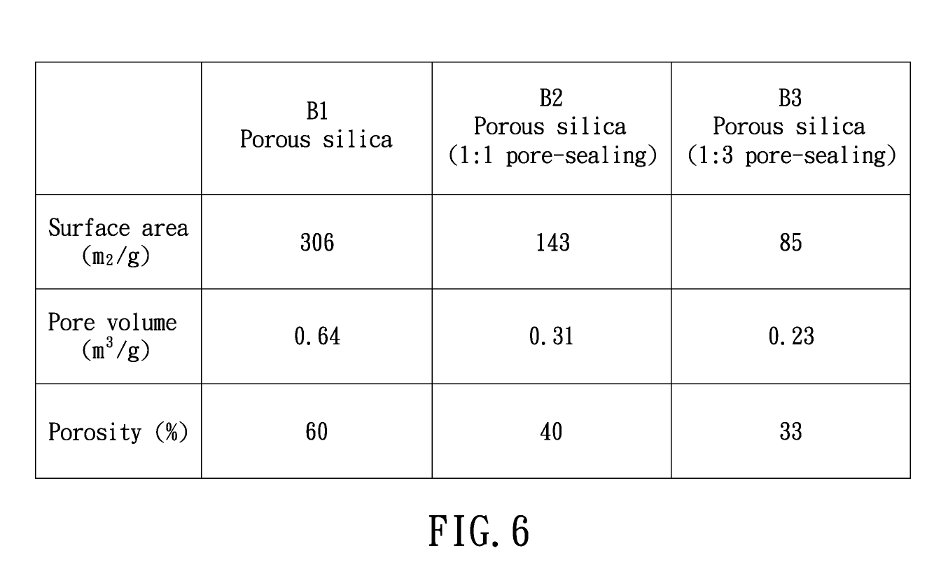

FIG. 6 is a data table of BET (specific surface area). Through experiment of the specific surface areas of different ingredients shown in FIG. 5, it is found that the surface area of unit B2 and unit B3, produced after the unit A2 and the unit A3 are respectively mixed, is much smaller than that of the original first basic material 10 (unit B1 after the unit A1 is mixed.) This indicates that the sacrificial material 30 of this invention can effectively permeate into the pores 11 of the first basic material 10 to diminish the surface area of the first basic material 10 and effectively cover up the pores 11 of the first basic material 10.

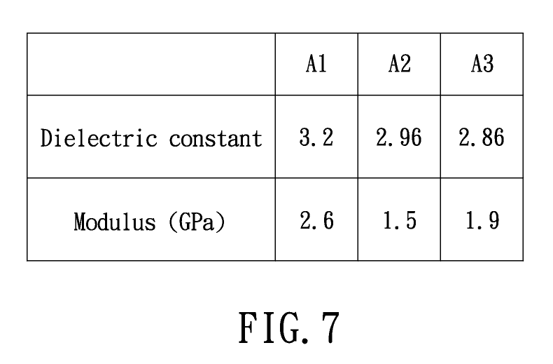

FIG. 7 is a table showing the dielectric constant and the elasticity modulus (GPa) of the sacrificial material 30 of the unit A1, the unit A2 and the unit A3. It can be found from this table that the dielectric coefficient of the unit A2 and the unit A3 is lower than that of the unit A1, but the elasticity coefficient of the unit A2 and the unit A3 respectively possesses certain strength. And, this result indicates that the method for forming a porous material in the present invention can make the second basic material 20 difficult to permeate into the pores 11 of the first basic material 10, able to increase the air content in the pores 11 of the first basic material 10 for lowering dielectric coefficient.

While the preferred embodiment of the invention has been described above, it will be recognized and understood that various modifications may be made therein and the appended claims are intended to cover all such modifications that may fall within the spirit and scope of the invention.

I claim:

1. A method for forming a porous material comprising:
a first step: preparing a porous first basic material, a second basic material and a sacrificial material that is compatible with said first basic material but incompatible with said second basic material;
a second step: mixing said first basic material with said sacrificial material in liquid state, said sacrificial material completely covering up pores of said first basic material under properly controlled temperature to form a first finished product; and
a third step: mixing said first finished product with said second basic material, said first finished product and said second basic material heated up to a vaporization temperature of said sacrificial material in coordination with a cross-linking reaction temperature condition needed by said second basic material, said sacrificial material heated and vaporized to exhaust out of pores of said first basic material, high viscosity produced by polymerization action of said second basic material enabling said second basic material to cover up outer side of said first basic material, ingredients in pores of said first basic material able to be reserved to form a second finished product.

2. The method for forming a porous material as claimed in claim 1, wherein said first basic material is an inorganic substance.

3. The method for forming a porous material as claimed in claim 2, wherein said inorganic substance is composed of one or more kinds of porous materials, such as silica, alumina oxide, silica-alumina, carbon-doped oxide (CDO), fluorinated silicate glass (FSG), calcium carbonate, alumina phosphate, alumina arsenate, alumina germanate, clay (kaolin, montmorillonite or mica powder), glass fiber and carbon fiber.

4. The method for forming a porous material as claimed in claim 1, wherein said second basic material is an organic substance.

5. The method for forming a porous material as claimed in claim 4, wherein said organic substance is composed of one or more kinds of materials, such as epoxy resin, acryl resin (acrylate), polyimide and PU resin (polyurethane).

6. The methods for forming a porous material as claimed in claim 1, wherein said sacrificial material can optionally employ one or more kinds of materials, such as siloxane, wax and the like.

7. The method for forming a porous material as claimed in claim 1, wherein said sacrificial material is hexamethy cyclotrisiloxane and its structure is:

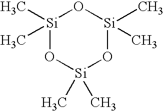

8. The method for forming a porous material as claimed in claim 1, wherein said first basic material and said sacrificial material are evenly mixed for a preset time at a temperature over a melting temperature of said sacrificial material and then kept stationary under room temperature to let said first basic material and said sacrificial material form a first finished product.

9. The method for forming a porous material as claimed in claim 8, wherein said sacrificial material and said first basic material are heated up to 65° C.˜100° C. and evenly mixed for one hour.

10. The method for forming a porous material as claimed in claim 1, wherein said first finished product is mixed with said second basic material in coordination with cross-linking reaction temperature condition of said second basic material, said cross-linking reaction temperature condition having room temperature rising up to 140° C.˜170° C. at a speed of 2° C. per minute and maintaining this temperature for one hour.

11. The method for forming a porous material as claimed in claim 1, wherein in said second step, said first basic material and said sacrificial material are mixed by means of closed thermal melting.

12. The method for forming a porous material as claimed in claim 1, wherein in said second step, said first basic material and said sacrificial material are mixed by means of solvent treatment.
